(19) United States
(12) Patent Application Publication
(10) Pub. No.: US 2007/0030481 A1
(43) Pub. Date: Feb. 8, 2007

(54) Molecular detector arrangement

(75) Inventor: Richard Gilbert, Chelmsford (GB)

Correspondence Address: Stephen J Rosenman;Seed Intellectual Property Law Group, 701 5th Avenue, Suite 6300, Seattle, WA, 98104-7092, US

(73) Assignee: E2V Technologies (UK) Limited

(21) Appl. No.: 10/520,986

(22) PCT Filed: Jul. 9, 2003
(86) PCT No.: PCT/GB03/02962

§ 371 Date: Jul. 27, 2005

(30) Foreign Application Priority Data
Jul. 10, 2002 (GB) 0215876.4
Apr. 25, 2003 (GB) 0309492.7

(51) Int. Cl. G01J 3/44; G01N 21/65

(52) U.S. Cl. 356/301

(57) ABSTRACT

A detector assembly for detecting the presence of analyte molecules, in particular, proteins, uses both Surface Enhanced Raman Scattering (SERS) and Surface Plasmon Resonance (SPR) in synergy. The excitation laser used for SERS provides scattering from a reporter dye to which an analyte molecule is attached in the vicinity of a conducting surface. Simultaneously, a second laser is provided at the critical angle to the conducting surface. The second laser causes a field to be created in the region of the analyte which enhances the Raman scattering effect.

### FIELD OF THE INVENTION

The present invention relates to a molecular detector, to a carrier for use in molecular detector and in particular to a molecular detector assembly of carrier and detector, which uses surface, enhanced Raman scattering.

### BACKGROUND OF THE INVENTION

It is known that there are many techniques to detect the action or presence of analyte molecules. One such technique utilises the Raman Scattering (RS) effect. Light incident on a molecule is scattered and, as a result of a transfer of energy, a shift in frequency, and thus wavelength, occurs in the scattered light. The process leading to this inelastic scatter is termed the Raman effect. The shift in frequency is unique to the analyte molecule. The RS effect, however, is very weak, so a technique preferably using colloids is known to be used to enhance the effect. Analyte molecules placed within a few Angstroms of a metal surface, such as silver, gold, copper or other such materials, experience a transfer of energy from the metal surface through various mechanisms. This is known as Surface Enhanced Raman Scattering (SERS) and can be measured using conventional spectroscopic detectors.

We have appreciated the problem that the Raman scattering effect, even using surface enhanced Raman scattering (SERS), provides a small amount of Raman scattered radiation in comparison to normal scattering (effectively a poor signal to noise ratio).

### SUMMARY OF THE INVENTION

The invention is defined in the claims to which reference is directed. An embodiment of the invention uses surface enhanced Raman scattering (SERS) to detect the presence of an analyte in a region near the surface using a first laser source incident on the region, but further enhances the SERS effect using a second laser incident on a surface to generate a field. The field generated in the region by the second laser is used enhance the Raman scattering effect.

The second laser incident on the surface is preferably used additionally for surface plasmon resonance detection (SPR) so that both SERS and SPR detection techniques can be used simultaneously. The SPR laser thus provides both a function of SPR and enhances the SERS effect as well.

### BRIEF DESCRIPTION OF THE FIGURES

Embodiments of the invention will now be described, by way of example only, and with reference to the accompanying drawings, in which:

FIG. 1 shows energy levels of Raman scattering;

FIG. 2 is a schematic diagram showing a detector using the principle of Surface-Enhanced Raman Scattering;

FIG. 3 is a schematic diagram showing a detector using the principle of Surface Plasmon Resonance;

FIG. 4 is a schematic diagram showing a detector arrangement using a combination of Surface-Enhanced Raman Scattering and Surface Plasmon Resonance according to the invention;

FIG. 5 shows an analyte carrier and detector together forming a detector assembly according to a first, preferred embodiment of the invention;

FIG. 6 shows an analyte carrier according to a second embodiment of the invention; and

FIG. 7 shows an analyte carrier according to a third embodiment of the invention.

### DESCRIPTION OF EMBODIMENTS OF THE INVENTION

The embodiments described uses the technique of Surface Enhanced Raman Spectroscopy (SERS) in synergy with Surface Plasmon Resonance (SPR). These techniques in combination, we have appreciated, can use the incident radiation of laser used for SPR to enhance the SERS effect. The present embodiments comprise two main components: an analyte carrier which provides an analyte region to support molecules to be analysed; and a detector which provides laser radiation to the analyte region on the carrier and has sensors to detect radiation received from the analyte region. Together the analyte carrier and detector comprise a detector assembly.

The detector itself can comprise various forms of laser source and sensors as described later. The embodiments of analyte carrier, appropriate to the detector can take various forms. The preferred embodiment is a microfluidic chip, but other embodiments include a suitably modified microtiter plate or a prism arrangement also as described later. The analyte carrier is thus a so called “lab on chip”. Prior to describing the embodiments, the SERS and SPR effects will first be described by way of background.

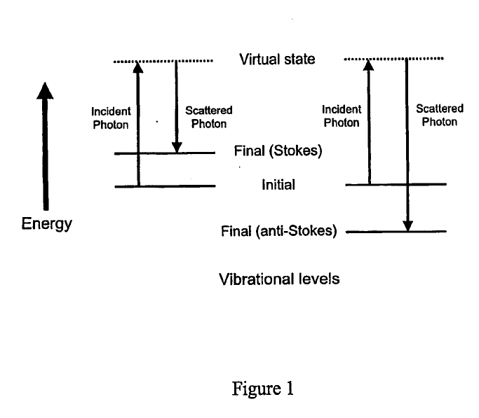

When light is scattered from a molecule, most of the photons are elastically scattered. The majority of the scattered photons have the same energy (and therefore frequency and wavelength) as the incident photons. However, a small fraction of the light (approximately 1 in 10⁷ photons) is scattered at frequencies different from, and usually lower than, the frequency of the incident photons as shown in FIG. 1. When the scattered photon loses energy to the molecule, it has a longer wavelength than the incident photon (termed Stokes scatter). Conversely, when it gains energy, it has a shorter wavelength (termed anti-Stokes scatter).

The process leading to this inelastic scatter is termed the Raman effect, after Sir C. V. Raman, who discovered it in 1928. It is associated with a change in the vibrational, rotational or electronic energy of the molecule, with the energy transferred from the photon to the molecule usually being dissipated as heat. It is also possible for thermal energy to be transferred to the scattered photon, thus decreasing its wavelength. In classical terms, this interaction can be viewed as a perturbation of the molecule's electric field, which is dependent not just on the specific chemical structure of the molecule, but also on its exact conformation and environment. The energy difference between the incident photon and the Raman scattered photon is equal to the energy of a vibrational state of the scattering molecule, giving rise to scattered photons at quantised energy values. A plot of the intensity of the scattered light versus the energy (wavelength) difference is termed the Raman spectrum [RS]. An explanation of the different energy states is shown in FIG. 1.

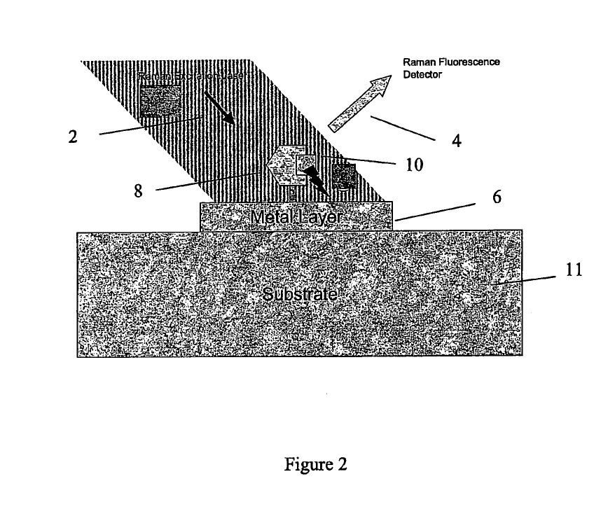

FIG. 2 shows how the Raman scattering from a compound or ion within a few tens of nanometers of a metal surface can be 10³ to 10⁶ times greater than in solution. This Surface-Enhanced Raman scattering (SERS) is strongest on silver, but is readily observable on gold and copper as well. Recent studies have shown that a variety of transition elements may also give useful SERS enhancements. The SERS effect is essentially caused by an energy transfer between the molecules and an electromagnetic field near the surface of a metal caused by electrons in the metal. The precise mechanism that leads to the enhancement of Raman scattering using SERS need not be described here and various models such as coupling of an image of an analyte molecule to electrons in the metal are known to the skilled person. In effect, electrons in the metal layer 6 supply energy to the molecule thereby enhancing the Raman effect.

The presence of a particular molecule is detected using SERS by detecting the wavelength of scattered radiation shown as scattered beam 4. The scattering is not directional and so the sensor (not shown) could be at any reasonable position to capture scattered radiation to measure the wavelength, and hence energy change, of the scattered radiation. The energy change is related to the band gap of molecular states, and hence the presence of particular molecules can be determined. Typically, a molecule 10 to be analysed is bound to a reporter molecule 8 for analysis.

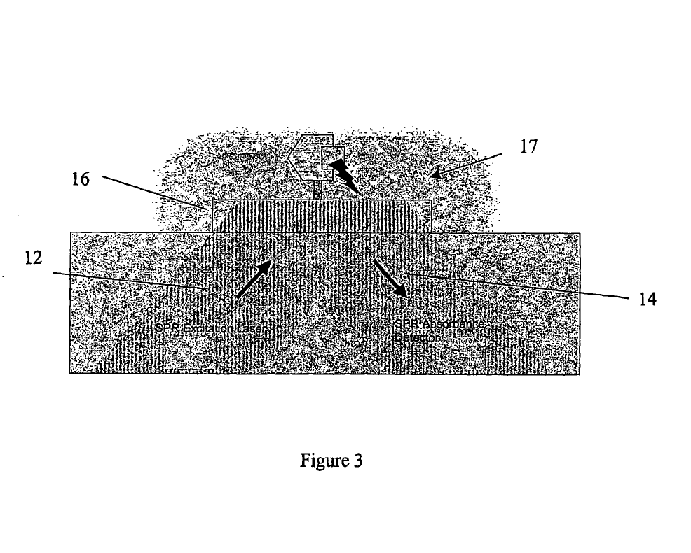

A different technique for measuring the presence of molecules is known as surface plasmon resonance (SPR) and is shown in FIG. 3. The electric vector of an excitation laser beam 12 induces a dipole in the surface of a metal layer 16. The restoring forces from the positive polarisation charge result in an oscillating electromagnetic field at a resonant frequency of this excitation. In the Rayleigh limit, this resonance is determined mainly by the density of free electrons at the surface of the metal layer 16 (the ‘plasmons’) determining the so-called ‘plasma wavelength’, as well as the dielectric constants of the metal and its environment.

Molecules in an analyte absorbed on or in close proximity to the surface of the layer 16 experience an exceptionally large electromagnetic field in which vibrational modes normal to the surface are most strongly enhanced. This is the Surface Plasmon Resonance (SPR) effect, which enables through-space energy transfer between the plasmons in the metal layer 16 and the molecules 8 near the surface. Scattered photons may then be measured using conventional spectroscopic detectors (not shown).

The intensity of the SPR is dependent on many factors including the wavelength of the incident light and the morphology of the metal surface, since the wavelength of incident light should be such that the energy matches that of the plasma wavelength of the metal. SPR can be performed using colloidal metal particles or thin metal films. For a 5 μm silver particle the plasma wavelength is about 382 nm, but it can be as high as 600 nm for larger ellipsoidal silver particles. The plasma wavelength is to the red of 650 nm for copper and gold particles, the other two metals which show SERS at wavelengths in the 350-1000 nm region. The best morphology for surface plasmon resonance excitation is a small (<100 nm) particle or an atomically rough surface on a thin (ca. 50 nm) metal film.

As shown in FIG. 3, for SPR, an excitation laser beam 12 of plane polarised light is arranged so that it impinges on the metal surface 16 close to the critical angle. This critical angle is determined by the refractive index of the metal. The SPR effect produces an evanescent wave 17, an electromagnetic field, which extends approximately 400 nm from the metal surface. An energy transfer between this field and the analyte molecules results in a change in the effective refractive index of the layer 16 causing a change in the critical angle and hence a change in the intensity of refracted light 14, which can be detected using conventional spectroscopic devices.

Both the RS and SPR are powerful techniques which are routinely used to follow molecular interactions or quantify molecules at extremely low concentrations.

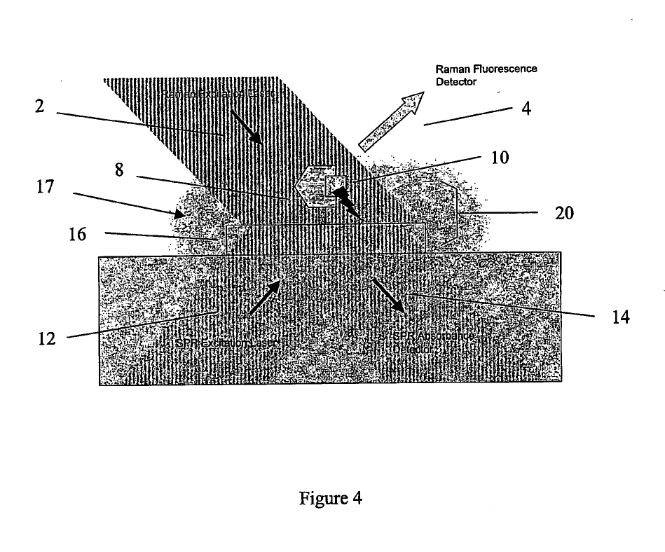

The principles of operation of the embodiments of the invention are shown in FIG. 4. A key feature of the embodiments is that the SERS effect for detecting presence of molecules is enhanced by use of an additional incident laser source, which is preferably also used for SPR detection. The two detector systems can operate independently, giving discreet or simultaneous measurements of the same analyte sample. The effects behave synergistically, selectively enhancing the interaction between the surface plasmons and the analyte molecules.

The features previously described in relation to FIGS. 2 and 3 are given the same numbering in FIG. 4. A first laser source, a SERS excitation laser beam 2, is incident on a receptor molecule 10, typically an antibody which is bound to a reporter molecule 8 at a metal surface 16 which is electrically conductive. The analyte molecules are typically protein molecules. When an analyte molecule binds to the receptor molecule, the reporter molecule is displaced and comes close to the surface, thereby showing an enhancement in the SERS scattering. In known fashion, as described above, SERS scattering occurs and the scattered radiation 4 is detected by a sensor. At the same time, a second laser source, an SPR laser beam 12, is incident on the metal surface 16. The second laser beam couples with surface plasmons, which in turn generate an electromagnetic field, which couples with vibrational energy states of the molecules to be analysed.

The efficiency of energy transfer between the molecular system and the plasmon field is dependant upon a match between the vibrational energy states of the molecule, and the quantum energy states of the surface plasmons. The former is determined by the molecular structure and environment, and the latter by the wavelength of the excitation laser and composition and geometry of the metal particle layer. Therefore, if the excitation wavelength of the SPR beam 12 is varied (e.g. by using a tunable laser) or the composition and thickness of the metal layer 16 is altered, the SPR effect can be selectively optimised to maximise the SERS signal from a particular analyte molecule. The benefits of this are that the strength of the SERS signal can be substantially increased for a given molecule (enabling more sensitive detection), and that the SPR electromagnetic field in a region 20 can be adjusted to selectively enhance the signal from particular components of complex biological mixtures. Since the combined detector uses an artificial SPR field to enhance the fluorescence from the analyte molecules, we have named the technique Surface Plasmon Assisted Raman Spectroscopy (SPARS). Effectively, the second laser is used to pump energy into the excitation produced by the first laser.

The preferred embodiment of the invention is to apply the new technique described above in a so called lab on chip device. In this arrangement, an analyte carrier is provided (which is disposable) to which a solution containing the molecules to be analysed is added. The carrier is then inserted into a detector comprising two lasers (one for SERS and one for SPR excitation) and a sensor arrangement to detect the Raman scattered radiation and optionally the SPR radiation.

The embodiments of analyte carrier will now be described, as well as describing the whole carrier and detector assembly.

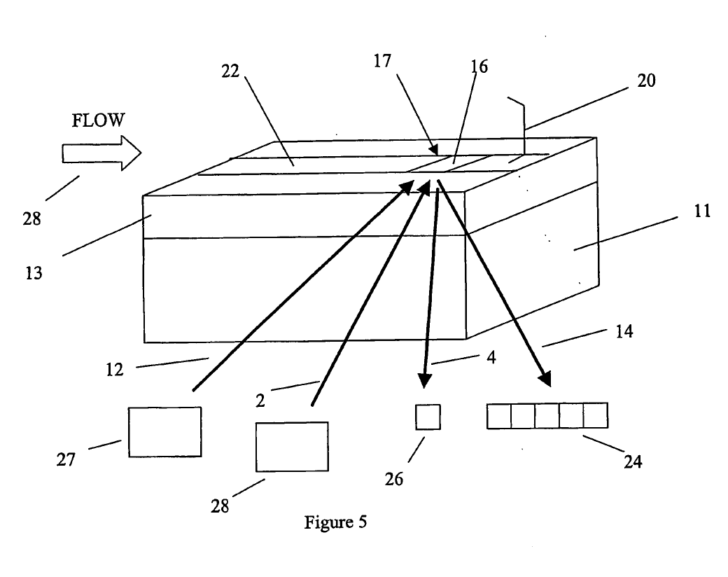

The preferred embodiment of analyte carrier is shown in FIG. 5 and is a form of microfluidic chip. On a substrate 11 of suitable plastic, glass or other appropriate material that is transparent to radiation at the chosen wavelengths, is formed a channel layer 13 having a channel 22. Analyte in solution is introduced to the channel in the direction shown by an arrow. At a region 17 of the channel a conductive or semiconductive layer 16 is formed. This layer is preferably one of copper, aluminium, silver or particularly gold. As previously described, the gold layer maybe colloidal of particle size of the order 80 nm, the particle size within the metal colloid being chosen to provide an appropriate plasmon wavelength as already described.

A primary use of the chip is in the detection of proteins. For this use, a reporter dye is provided on the gold surface 16 having a linking molecule to which an antibody or similar receptor attaches, and also a peptide or similar fragment able to mimic a portion of the target protein. The reporter dye is initially held away from the surface by binding to the receptor site on the antibody or receptor molecule. On binding of a target protein, the reporter is displaced and comes within the region 20 of influence of the evanescent field from the metal surface. The reporter dye is chosen depending upon the protein to be analysed. It is the reporter molecule that provides the SERS scattering as enhanced by the SPR laser.

The detector into which the analyte carrier chip is inserted comprises a SERS laser 28 providing a beam 2 to the analyte and reporter molecules at the surface region 17 of the gold layer 16. The SERS laser 28 provides radiation at a wavelength chosen to match a bandgap of the reporter molecule and will vary from molecule to molecule. To provide a flexible detector, therefore, the SERS laser is preferably tunable. As SERS scattering 4 is not directional, the sensor 26 for the scattered radiation could be at any position. However, this sensor is preferable not opposite the SERS laser to avoid direct radiation from the laser reaching the sensor.

A laser 27 to provide a plane polarised beam 12 for the SPR effect is provided at the critical angle to the surface 16, and a sensor array 24 positioned so as to receive the reflected beam 14. The SPR laser 27 is chosen to have a wavelength to match the surface plasmon resonance, which itself is arranged to couple with the bandgap of the reporter dye molecules. Thus, it is also preferable that the SPR laser 27 is tuneable. The sensor array 24 comprises multiple sensor, each at a slightly differing angle to the reflected beam. Accordingly, as the reporter molecule interacts with the evanescent wave from the surface 16 it changes the SPR refracted radiation which can be detected as a change in angle of the refracted light. Also, as the SPR laser is tuneable, the SPR effect can be measured by sweeping the tuning of the laser and noting the variation in the wavelength at which the refraction occurs for a given detector position when an analyte molecule attaches to the receptor molecule.

Although shown with just one channel, the chip preferably has multiple channels, each of which may contain a different reporter dye and/or receptor molecule on the metal layer.

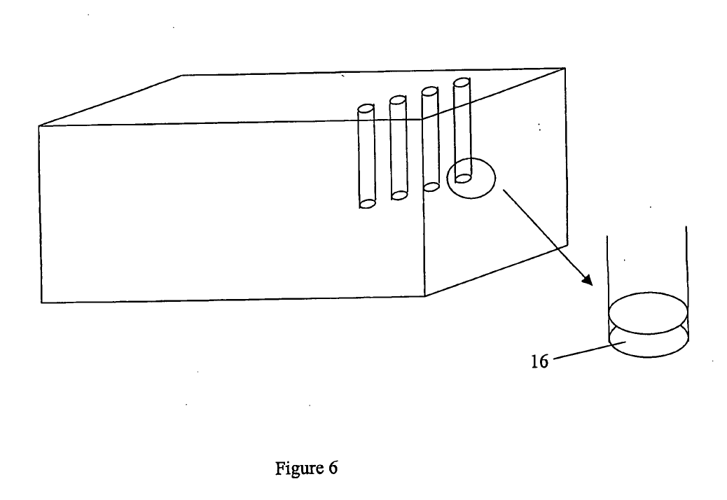

A second embodying analyte carrier is shown in FIG. 6 and comprises a modified microtiter plate. A microtiter plate is known to the skilled person and comprises a series of wells in a substrate, typically of plastic. Samples of an analyte are introduced to the microtiter plate wells for analysis. In accordance with the embodiment of the invention, the bottom of each well, or sides, is modified to include a conductive surface 16 onto which a reporter dye is placed. The analyte in solution is then introduced into each well and the plate inserted into a detector as previously described in relation to FIG. 5. The conductive surface is preferably gold of typical thickness 50 to 80 nm as previously described. The detector arrangement can illuminate each well in turn, but preferably has an array of detectors to allow simultaneous illumination and detection from each of a plurality of wells in the plate.

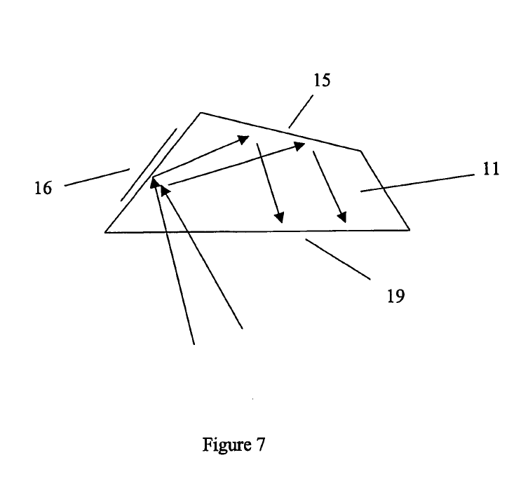

A third embodiment of chip is shown in FIG. 7. In this arrangement, a prism is effectively created from a substrate 11 having a reflective surface 15 and a surface 19 on which sensors are mounted for external connection. The gold layer is provided on a side or the prism. The gold layer, lasers and arrangement of sensors is as described in relation to the first embodiment.

For any of the above “lab-on-a-chip” devices, there is the additional possibility of controlling the exact composition of the metal layer 16. Modifying the metal surface 16 with a variety of dopant atoms would provide an additional means of modulating the plasma wavelength, maybe even resulting in an electronically-controllable SPR field.

The RS and SPR components can be physically separated, with the RS laser and detector arranged ‘above’ the analyte molecules, and the SPR laser and detector arranged ‘below’ them. Alternatively, both lasers may illuminate the detector surface from the same side. The benefit of this for a lab-on-a-chip application is that it provides modularity: detectors can be built in all three combinations (RS only, SPR only, and SPARS) using the same basic components.

1.-33. (canceled)

34. A detector assembly for detecting the presence of a molecule in an analyte comprising:
an analyte carrier having a conducting surface for receipt of an analyte in an analysis region of the surface;
a first laser radiation source arranged to provide radiation directed, in use, to the analysis region to cause Raman scattering;
a first sensor arranged to detect radiation from the first laser radiation source that has been scattered from the analysis region by Raman scattering to detect the presence of the molecule;
a second laser radiation source arranged to provide radiation, in use, to the conducting surface at an angle to the conducting surface such that a field is generated in the analysis region;
wherein the first and second laser radiation sources and the conducting surface and wavelength of the second radiation source are arranged such that the field generated by the second laser source matches a band gap of the Raman scattering and thereby causes an enhanced Raman scattering effect of radiation of the first laser source.

35. A detector assembly according to claim 34, wherein the conducting surface comprises a colloidal metal film.

36. A detector assembly according to claim 34, wherein the metal film is one of aluminium, copper, silver or gold.

37. A detector assembly according to any one of claims 34-36, wherein the conducting surface has a thickness of the order 10-100 nm.

38. A detector assembly according to any one of claims 34-36, wherein the conducting surface has deposited thereon a reporter dye having a binding molecule for selectively binding to an analyte molecule to be analyzed.

39. A detector assembly according to claim 38 wherein the reporter dye is arranged so that, in use, the reporter dye is in the analysis region on binding with a molecule to be analyzed.

40. A detector assembly according to any one of claims 34-36, wherein the analyte carrier comprises a microfluidic chip.

41. A detector assembly according to claim 40, wherein the microfluidic chip includes at least one channel, a portion of the channel having the conducting surface thereon.

42. A detector assembly according to claim 40, wherein the microfluidic chip includes multiple channels, each channel having a portion with a conducting surface thereon, each conducting surface having a different reporter dye deposited thereon.

43. A detector assembly according to any one of claims 34-36, wherein the carrier comprises a microtiter plate.

44. A detector assembly according to claim 43, wherein the microtiter plate has one or more wells, each well having the conducting surface at a bottom portion thereof.

45. A detector assembly according to any one of claims 34-36, wherein the carrier comprises a prism arrangement, the conducting surface being arranged on one face of the prism.

46. A detector assembly according to any one of claims 34-36, wherein the second laser radiation source is arranged to provide plane-polarised radiation to the conducting surface.

47. A detector assembly according to claim 46, wherein the second laser radiation source is arranged to provide radiation at or near the critical angle to the conducting surface.

48. A detector assembly according to any one of claims 34-36, wherein the conducting surface has surface plasmons of a surface plasmon wavelength, and the second laser radiation source is arranged to provide radiation at substantially the surface plasmon wavelength.

49. A detector assembly according to claim 47, wherein the second laser source is arranged for surface plasmon resonance detection, the detector assembling further comprising a second sensor arranged to detected radiation from the first laser light source refracted from the surface.

50. A detector assembly according to claim 49, wherein the second sensor comprises a single sensor arranged to detect a change in intensity of the refracted radiation to detect the presence of the molecule.

51. A detector assembly according to claim 49, wherein the sensor comprises an array of sensors arranged to detect a change in angle of the refracted radiation to detect the presence of the molecule.

52. An analyte carrier for use in a detector assembly in which laser radiation from a first source is used to detect the presence of an analyte by Raman scattering, and laser radiation from a second laser radiation source is used to generate a field to enhance the Raman scattering, comprising:
a substrate for supporting the analyte and having optical properties chosen to match the laser radiation from the first or second radiation sources; and
a conducting surface on a portion of the substrate for receipt of the analyte.

53. An analyte carrier according to claim 52, wherein the conducting surface comprises a colloidal metal film.

54. An analyte carrier according to claim 53, wherein the metal film is one of aluminium, copper, silver or gold.

55. An analyte carrier according to claim 52, wherein the conducting surface has a thickness of the order 10-100 nm.

56. An analyte carrier according to claim 52, wherein the conducting surface has deposited thereon a reporter dye having a binding molecule for selectively binding to an analyte molecule to be analyzed.

57. An analyte carrier according to claim 56, wherein the reporter dye is arranged so that, in use, the reporter dye is in the analysis region on binding with a molecule to be analyzed.

58. An analyte carrier according to claim 52, wherein the analyte carrier comprises a microfluidic chip.

59. An analyte carrier according to claim 58, wherein the microfluidic chip includes at least one channel, a portion of the channel having the conducting surface thereon.

60. An analyte carrier according to claim 58, wherein the microfluidic chip includes multiple channels, each channel having a portion with a conducting surface thereon, each conducting surface having a different reporter dye deposited thereon.

61. An analyte carrier according to any one of claims 53 to 58, wherein the carrier comprises a microtiter plate.

62. An analyte carrier according to claim 61, wherein the microtiter plate has one or more wells, each well having the conducting surface at a bottom portion thereof.

63. An analyte carrier according to any one of claims 52 to 57, wherein the carrier comprises a prism arrangement, the conducting surface being arranged on one face of the prism.

64. A detector for detecting the presence of a molecule in an analyte on an analyte carrier having a conducting surface for receipt of an analyte in an analysis region of the surface, comprising:
a first laser radiation source arranged to provide radiation directed, in use, to the analysis region to cause Raman scattering;
a first sensor arranged to detect radiation from the first laser radiation source that has been scattered from the analysis region by Raman scattered from the analysis region by Raman scattering to detect the presence of the molecule;
a second laser radiation source arranged to provide radiation, in use, to the conducting surface at an angle to the conducting surface such that a field is generated in the analysis region;
wherein the first and second laser radiation sources and the conducting surface and wavelength of the second radiation source are arranged such that the field generated by the second laser source matches a band gap of the Raman scattering and thereby causes an enhanced Raman scattering effect of radiation of the first laser source.

65. A method of detecting the presence of a molecule in an analyte, comprising:
providing the analyte on an analysis region of a conducting surface;
illuminating the analysis region with first laser radiation to cause Raman scattering;
detecting radiation scattered from the analysis region by Raman scattering to detect the presence of the molecule;
simultaneously illuminating the conducting surface with second laser radiation at an angle to the conducting surface and wavelength such that the field generated by the second laser source matches a band gap of the Raman scattering to generate a field in the analysis region; and
wherein the field generated in the analysis region enhances the Raman scattering effect.
